(19) United States
(12) Patent Application Publication
(10) Pub. No.: US 2022/0295823 A1
(43) Pub. Date: Sep. 22, 2022

(54) METHOD FOR PRODUCING AQUATIC MACROPHYTE MEAL FOR ANIMAL FEEDS AND AQUATIC MACROPHYTE MEAL OBTAINED

(71) Applicant: Marcus Cesar DE SOUZA FONSECA, São Paulo (BR)

(72) Inventor: Marcus Cesar DE SOUZA FONSECA, São Paulo (BR)

(21) Appl. No.: 17/627,647

(22) PCT Filed: Jul. 16, 2020
(86) PCT No.: PCT/BR2020/050264

§ 371 Date: Jan. 15, 2022

(30) Foreign Application Priority Data
Jul. 16, 2019 (BR) 10 2019 014687-7

(51) Int. Cl. A23J 1/00; A23K 10/30; A23K 20/147; A23L 19/00; A23L 11/00; A23L 33/185

(52) U.S. Cl. CPC A23J 1/007; A23K 10/30; A23K 20/147; A23L 19/09; A23L 11/07; A23L 33/185; A23V 2002/00

(57) ABSTRACT

Management and processing of floating aquatic plants such as the species Pistia stratiotes (Araceae) and other water macrophytes produce (I) macrophyte paste, (II) macrophyte broth, (III) macrophyte bagasse, (IV) macrophyte bran and (V) macrophyte protein concentrates. The interaction of these by-products with ingredients used in animal and human feed significantly increase the final protein concentration of the feed obtaining high potential to supply animal and human demands for protein. The system provides a sustainable model for protein production that provides the essential benefits of treating effluent with high concentrations of organic matter in bodies of water such as rivers, lakes and dams to thereby provide an incalculable capacity for producing animal feeds and great potential for meeting human demand for protein.

### TECHNICAL FIELD

This invention patent regards the production of protein from the processing of floating water macrophytes, mostly with the species Pistia stratiotes (Araceae), but not only restricted to that species, more specifically belonging to the field of biomass production in the form of paste, broth, bagasse, bran and protein concentrates. The interaction of these by-products with ingredients used in animal and human feed significantly increase the final protein concentration of the feed obtaining high potential to supply animal and human demands for protein.

### BACKGROUND OF THE INVENTION

For a better understanding of the facts, the state of the art should be divided in relation to water macrophytes in 2 (two) perspectives. The regional state of the art, restricted to the district surrounding the dam, source of macrophyte biomass, and the state of the art based on scientific research, as well as the medicinal ancient customs of the use of these plants, used by Indian population and primitive folk.

In the regional perspective, district surrounding the dam, macrophytes have always been treated as invasive, weed, which should be eliminated from water surface of local dams. It is customary for rural landowners in the region to have a specific budget for plant extermination, without any use of the biomass removed from lakes and dams.

In the academic perspective, water macrophytes apparently occupy an opposite field to the regional perspective. There are several studies that highlight positive aspects of these plants as: effluent treatment, potential use of biomass as fertilizers, use as supply (part of the feed) for animals, medicinal applications, biogas production with increased methane concentration when mixed with animal manure, etc. On the other hand, there are also numerous scientific studies on methods to exterminate these plants, considered weeds for producers of hydroelectric power and agricultural producers in general. The treatments control for macrophytes involve pesticides, banned in several countries, and, also, through natural predators, biological control. However, nothing stops the reproduction cycle of these plants when the habitat is rich in organic matter available in watercourses. In general, every region on the planet, mainly in tropical and subtropical countries, the occupation capacity of these plants in lakes, dams and waterways is perceived.

Some examples of processes involving floating macrophytes can be seen in patent document PI 0804380-9 related to production of humus, fertilizers and earthworms from water plants, or patent document BR 102018014640-8 (Federal University of Bahia) that deals with the production process, formulation and use of sustainable bioinorganic accelerators to obtain compound organic fertilizer.

Patent document BR 102012005977-0 (Federal University of Parana) relates to a process for industrial use of liquid organic waste to produce biogas (methane); solid organic fertilizer, mineral organic and/or source of nutrients for plants and to obtain reusable water in agro-industrial systems. Patent document CN104171339 (Deng Dingxun) deals with a method for the production of feed protein, fermenting Pistia stratiotes through light tube plate.

### History of the Invention

During the 1997/98/99 triennium, through the design and construction of the dam named ALS, in Sobradinho region (Colony river), this river divides the county of Itororó and Itapetinga in the state of Bahia, Brazil. At that time, empirical research began with the plants. During the lake formation period, water retained by the ALS dam, the multiplication power of these plants was observed to completely cover a water surface of more than 5 hectares, equivalent to more than 50,000 m² (fifty thousand square meters) in less than 60 days. The main reason for this uncontrollable reproduction of plants is based on the fact that the city of Itororó, in the state of Bahia-Brazil, is located about 6 kilometers upstream the dam, thereby providing a permanent source of organic matter to feed the floating roots of the dam's macrophytes.

It is known that more than 80% of the plants that inhabit this lake are of the species Pistia stratiotes (aracea), regionally known as “golfo”, and in other regions known as “water lettuce”. After filling the lake, already in the decade between 2010/2020 the region experienced great droughts and the only green vegetation on the rural property was found in the lake, covered by macrophytes. The most abundant species was not palatable, and animals did not consume it in natura, unlike “aguapé”, erichornia crassipes, which if placed in the trough were consumed by animals (horses, cattle, among others). From the impossibility of using most of the macrophytes as feed, research was started with the goal of making use of the creation as food. There was, however, a regional cultural issue against this use by rural workers and neighboring producers, based on fact that if an animal does not consume it in natura, it would have no use as feed. This mystique was undone when several macrophytes were removed from the reservoir and left on dry soil, under a scorching sun, so that the plants dehydrated and were totally consumed by livestock. However, the demand for feed due to the amount of cattle to feed made biomass drying unsustainable. The basis in studies and local observation led to the practical certainty that eating macrophytes did not harm livestock.

### DESCRIPTION OF THE INVENTION

So done, the technical development based on the observations discussed above made a first by-product of macrophytes, called “pasta de golfo” (gulf paste), the result of processing macrophytes in a grinder machine, made for cutting grass. The material was sent to Federal University of Bahia and the result of the bromatological analysis indicated that the paste held more than 90% of water in the composition and about 17.58% of protein over the dry matter.

Due to the excessive amount of water in the macrophytes and the problem of palatability, several mixtures of ingredients were added to the composition of the feeds. Among them, corn silage mixed with macrophyte paste was used, resulting in a good milk productivity and avoiding the mortality of beef cattle by lack of pasture on the property due to the drought in the region.

Still in research, corn bran, soy bran, wheat bran and molasses were mixed as components of the feed. These additions solved the problem of palatability.

At the end of the dry season and with the return of regular rains, research aimed at storing this macrophyte paste in the period of regular rains, around 3 months, being used again in the dry season. The excessive amount of water in the ground and stored macrophyte, that is, more than 90% of the by-product led to store, in silo, macrophytes enriched by adding a minimum amount of bran, mainly soy (the most expensive ingredient per ton in the region). To prevent rot of the silo, the macrophyte paste was pressed to remove excess of water, then mixed with the bran, so that the mixture of macrophyte paste and bran was obtained for storage.

The macrophyte broth, as result of the pressing of plant paste, initially discarded for being practically a green water with truly little concentration of plant nutrients was stored in a tank, to which

soybean meal was mixed in a volumetric ratio of 1 to 3, that is, 10 liters of soybean meal for 30 liters of macrophyte broth. This product mix was arranged in 50-liter buckets, closed, and left to rest for about 12 (twelve) hours.

The reaction between the soybean meal and the macrophyte broth resulted in a third by-product of the production in terms of, yellowish in color, consistent and extremely palatable for cattle, superior to the pure soy bran itself, becoming called “Farelo Ouro D'água” (Gold's Water bran), the result of a mixture of 3 parts of macrophyte broth for 1 part of soy bran.

As the silo were ready for consumption, samples were taken for bromatological analysis. The results were analyzed comparatively over the time focusing on 2 (two) parameters, percentage of dry matter and percentage of protein in the dry matter of all by-products: macrophyte paste, macrophyte broth, gold's water bran and macrophyte silos enriched with bran.

Some samples showed deviations in the results in relation to protein concentration, based on the protein calculation equations scientifically adopted for mixtures of ingredients with different protein concentrations. Initially, deviation was attributed to improper handling of samples, contamination or another unknown factor. However, the transformation was clear in terms of food, color, smell, palatability, mainly in the by-product “Farelo Ouro D'água” (Gold's Water bran), composed of macrophyte broth and soybean meal. From this step, a high content of protein is obtained in some mixtures due to the handling, processing and addition of ingredients to the multiple combinations of by-products from water macrophytes.

Other experiments were carried out based on the use of concentrates “whey protein” type. However, bromatological results did not present the same property identified in the by-products of macrophytes and soybean meal. With launch of vegan protein concentrates, new experiments were carried out, adding, for that, the use of a centrifuge, aiming at a more efficient way to extract the broth and bagasse from the macrophytes.

The main objective of the present patent was to obtain a by-product of greater palatability coming from soybean meal and other proteins that, by different analyses, it was shown that the by-products of macrophytes, when mixed with vegan proteins made the whole mixture acquire the protein concentration of the protein added, approximately 50%, in the case of soybean meal, of the dry matter of the sample. In brief, the protein percentage of fresh water macrophytes are between 13% to 18% of protein, the percentage of protein, for example, of soybean meal is around 50%, the feed samples of by-products of water macrophytes with soybean meal, also had a 50% protein concentration in the dry mater. Empirically, there are no doubts that the obtained by-products of macrophytes differ from those existing in the research and documents of the prior art.

Surprisingly it was detected in the bromatological analyses that the identified property of the combination of by-products of water macrophytes and soybean meal, also occurred in the combination of by-products of water macrophytes and vegan protein concentrates, in other words, the by-products of water macrophytes acquired the protein concentration of vegan protein concentrate, well above 50% of soybean meal. This by-product was named “protein concentrate of water macrophytes”.

In view of the above, it became evident that the by-products of macrophytes, when mixed with some types of vegan ingredients, show a property not found in the prior art.

Many modifications and other modalities of the invention presented in this document will be reminded to a specialist in the technique to which this invention belongs, having the benefit of the teachings presented in the previous description. Therefore, it should be understood that the invention should not be limited to the specific modalities and that disclosures and modifications and other modalities should be included in the scope of the appended claims. Although specific terms are used here, they are used only in a generic and descriptive sense and not for the purpose of limitation.

1-6. (canceled)

7. A method for producing protein by processing of floating water macrophytes, the method comprising:
grinding the floating water macrophytes, the grinding including grinding of leaf, stem, and root portions of the floating water macrophytes to obtain a ground paste having more than 90% water and a balance of plant nutrients, mineral and microscopic particles from the floating water macrophyte habitat;
pressing the ground paste to obtain a broth of the floating water macrophytes containing plant nutrients;
separating the floating water macrophyte bagasse from the broth, the bagasse comprising less than 90% of water and mineral and microscopic particles from the floating water macrophyte habitat;
mixing the macrophyte broth with soybean meal in volumetric proportion of 1 part of a soybean meal to 3 parts of the macrophyte broth to obtain a macrophyte bran; and
configuring the macrophyte bran into a desired shape.

8. The method of claim 7, wherein a grass cutter is used for grinding the floating water macrophytes.

9. The method of claim 7, wherein centrifugation is used to separate the bagasse from the broth.

10. The method of claim 7, further comprising mixing the bagasse with soybean meal.

11. The method of claim 7, wherein the floating water macrophyte is of the Pistia stratiotes (Araceae) species.

12. The method of claim 7, further comprising enriching with vegan protein concentrate to obtain a mixture of products having a final protein value that reaches the magnitude of the vegan protein concentrate added to the mix.

13. A feed for human or animal consumption comprising a protein produced by the method of claim 7.

14. A method for producing protein by processing of floating water macrophytes, the method comprising:
grinding the floating water macrophytes, the grinding including grinding of leaf, stem, and root portions of the floating water macrophytes to obtain a ground paste having more than 90% water and a balance of plant nutrients, mineral and microscopic particles from the floating water macrophyte habitat;
pressing the ground paste to obtain a broth of the floating water macrophytes containing plant nutrients;
separating the floating water macrophyte bagasse from the broth, the bagasse comprising less than 90% of water and mineral and microscopic particles from the floating water macrophyte habitat;
mixing one of the paste, broth and bagasse with vegan protein to obtain a macrophyte bran; and
configuring the macrophyte bran into a desired shape.
